(19) United States
(12) Patent Application Publication
(10) Pub. No.: US 2008/0141482 A1
(43) Pub. Date: Jun. 19, 2008

(54) Pantograph-Type Windscreen Wiper

(75) Inventors: Jean-Pierre Eustache, Antony (FR); Franck Cathala, St. Martin Laguepie (FR)

Correspondence Address: OSHA LIANG L.L.P., 1221 MCKINNEY STREET, SUITE 2800, HOUSTON, TX, 77010, US

(73) Assignee: Valeo Systems d'Essuyage, La Verriere (FR)

(21) Appl. No.: 11/662,837

(22) PCT Filed: Sep. 15, 2005
(86) PCT No.: PCT/EP2005/009941

§ 371 Date: Sep. 18, 2007

(30) Foreign Application Priority Data
Sep. 16, 2004 (FR) 04 09818

(51) Int. Cl. B60S 1/34; B60S 1/08

(52) U.S. Cl. 15/250.21; 15/250.31; 15/250.351

(57) ABSTRACT

A pantograph-type windscreen wiper is disclosed, wherein the angular movement of the pantograph makes it possible to modify a wiper blade orientation on the plane of the pantograph rods and also to modify the blade attack angle, i.e. the angle between the blade and the normal to the windscreen surface. The wiper improves wiping performance, in particular on the lateral areas of a panoramic windscreen.

The present invention relates to a windscreen wiper with a pantograph, in particular for cars comprising a so-called “panoramic” windscreen.

A windscreen is described as panoramic when it comprises lateral end portions that extend back over the sides of the car, and thus has a heavily curved area on each side.

The problem that arises with this type of windscreen involves efficiently wiping not only the front part of the glass, which is generally only slightly curved, but also these heavily curved side end portions.

Some known solutions, such as that set forth in U.S. Pat. No. 2,691,186, suggest using complementary blades in order to wipe the side end portions. Such solutions are generally complex, and therefore costly, as well as being very bulky.

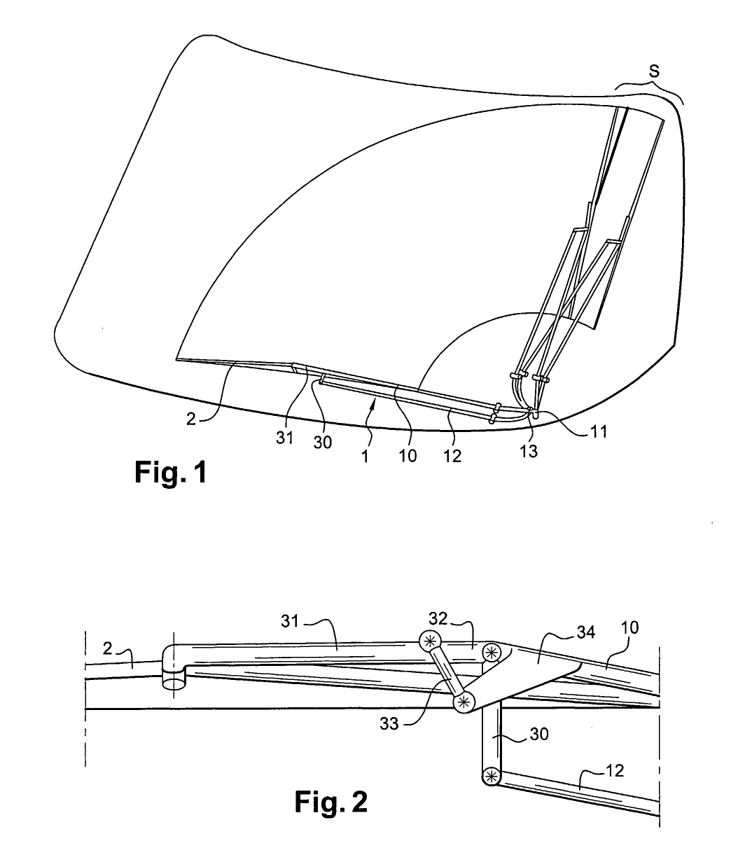

Another known solution involves using a pantograph-type windscreen wiper which optimises the trajectory of the wiper blade in relation to the windscreen in order to wipe a greater surface of the windscreen. The principle of such a pantograph-type windscreen wiper involves transmitting a non-circular trajectory to the wiper blade for at least some portions of the windscreen (in particular the side end portions), as opposed to a standard windscreen wiper which has a circular blade trajectory over the entire surface of the windscreen. For this purpose, the pantograph-type windscreen wiper comprises, as shown schematically in FIG. 1, an arm 1 supporting the blade 2 and made up of two rods substantially parallel to each other at rest, namely:
a first rod 10, henceforth referred to as the main rod, a rear end 11 of which has a fixed position, this main rod 10 being mobile in rotation, thanks to a rotational drive shaft of an electric motor (not shown) allowing an alternating sweeping movement about a main swivel axis passing though this rear end 11; and
a second rod 12, henceforth referred to as the secondary rod, the rear end 13 of which also generally has a fixed position, this secondary rod also being mobile in rotation about a secondary swivel axis which is parallel to but distinct from the main axis, and which passes though this rear end 13.

The windscreen wiper also comprises a substantially L-shaped end connecting rod, a first side 30 of the L shape connecting the other two ends, known as front ends, of the main 10 and secondary 12 rods respectively, and the other side 31 of the L shape supporting the windscreen wiper blade 2. The links are arranged so that the first side 30 of the L-shaped connecting rod can swivel in the plane of the rods 10, 12, on the one hand, in relation to the secondary rod 2 and, on the other hand, in relation to the main rod 10 about distinct axes of rotation, substantially parallel to the main swivel axis and to the secondary swivel axis, simultaneously driving the swivelling of the other side 31 of the L shape. In this way, the end connecting rod 30, 31, the main rod 10 and the secondary rod 12 form, together with the shell of the car, a deformable quadrilateral, and the blade 2 supported by the end connecting rod has an orientation with regard to the main 10 and secondary 12 rods which varies according to the relative angular position of these rods during their rotational movement about their respective swivel axes. This variation of the blade orientation is shown in FIG. 1 by the three distinct positions of the windscreen wiper: a first resting position in which the arm/blade arrangement is substantially aligned with the bottom edge of the windscreen, an intermediate position, and an extreme position. “Pantograph mode” will henceforth refer to the operation of a pantograph-type windscreen wiper in which this variation of the orientation of the wiper blade is obtained.

When correctly sizing the various elements above in relation to the size and shape of the windscreen, a linear displacement of the blade, in particular at the side end portion S, is obtained with such a pantograph-type windscreen wiper, as shown schematically by the intermediate position and the extreme position in FIG. 1, between which the orientation of the blade increases.

Nevertheless, such a pantograph-type windscreen wiper is not always suitable for obtaining good quality wiping. In fact, another criterion for obtaining quality wiping lies in the angle of attack of the blade, which is to say, the tilt of the blade at the point where it connects with the arm in relation to the perpendicular of the windscreen surface. During a complete sweep in one direction going from the resting position of the windscreen wiper to the extreme position, improved wiping quality is obtained if it is possible to change this angle of attack of the blade in relation to the area of the windscreen in which it is currently located.

The previously described pantograph windscreen wiper does not allow a variation of the angle of attack as specified above and, in the case of a panoramic windscreen, it is possible, as shown in FIG. 4A, for a blade 2 to form, at the side area, too high an angle of attack β with the perpendicular N of the windscreen. In particular, this results in the blade being positioned incorrectly as regards its angle of attack as it begins its return sweep towards the resting position.

The present invention aims to improve the previously described pantograph-type windscreen wiper to increase the wiping efficiency, even in the side end portions of the windscreen.

This aim is achieved according to the invention, which relates to a pantograph-type windscreen wiper, in particular for a car comprising a panoramic windscreen, of the type including an arm supporting a blade and made up of at least:
a main rod mobile in rotation about a main swivel axis passing through a rear end of the main rod;
a secondary rod mobile in rotation about a secondary swivel axis, substantially parallel to but distinct from the main swivel axis and passing through a rear end of the secondary rod;
linking means connecting the front ends of the main and secondary rods so as to be able to swivel in the plane of the rods in relation to, on the one hand, the main rod and, on the other hand, the secondary rod, during the rotational movements of these rods about their respective swivel axes;
attachment means to which the blade is fixed, the attachment means being solidly attached in rotation to the linking means in the plane of the rods so as to have an orientation in relation to the rods which varies according to the relative angular position of these rods during their rotational movement about their respective swivel axes;
characterised in that the arm also comprises drive means which transmit to said attachment means a rotational movement about an axis of rotation substantially perpendicular to the swivel axes so as to change the angle of attack of the blade in relation to the perpendicular of the windscreen according to the relative angular position of these rods during their rotational movement about their respective swivel axes.

Thus, by means of the invention, the same angular movement of the pantograph causes a variation not only of the orientation of the attachment means (and therefore of the blade) in the plane of the rods, but also of the angle of attack of the blade, namely the angle formed by the blade with the perpendicular of the surface of the windscreen.

In a particularly advantageous embodiment, in terms of simplicity, of the invention, the arm comprises a substantially L-shaped end connecting rod, a first side of which forms the linking means, and a second side of which, solidly attached in rotation to the first side, is connected to the attachment means so as to allow the rotation of the attachment means about said axis of rotation, and the drive means comprise a connecting rod connected by one end to a part of the attachment means and by the other end to a protrusion of either the main or secondary rod in order for the variation of the relative angular position of the main and secondary rods to drive a translational movement of the connecting rod, which then drives said rotational movement of the attachment means.

Furthermore, it can seem desirable only to allow variations of the blade orientation and/or variations of the angle of attack of the blade on certain sectors of the windscreen, in particular the side end portions of the windscreen.

Thus, in a particularly advantageous embodiment of the invention, the windscreen wiper also comprises a device powering the arm comprising at least one electric motor having a main drive shaft with an alternating direction of rotation allowing for alternating sweeping of said windscreen between a resting position and an extreme position of the windscreen wiper, and means for controlling the arm operating mode allowing the selection, on at least one sector of the windscreen, of a so-called circular operating mode, in which the main rod and the secondary rod move in rotation about their respective swivel axes without varying their angular position in relation to each other.

Thus, neither the orientation nor the angle of attack of the blade are subjected to modification caused by the movement of the rods on this sector.

The invention will be understood better from the following description of a preferred embodiment thereof, made in reference to the appended drawings, wherein:

FIG. 1, already described above, shows a schematic view of the resting, intermediate and extreme positions, respectively, of a pantograph-type windscreen wiper of the prior art;

FIG. 2 shows a schematic top view of the main elements of a windscreen wiper according to a preferred embodiment of the invention;

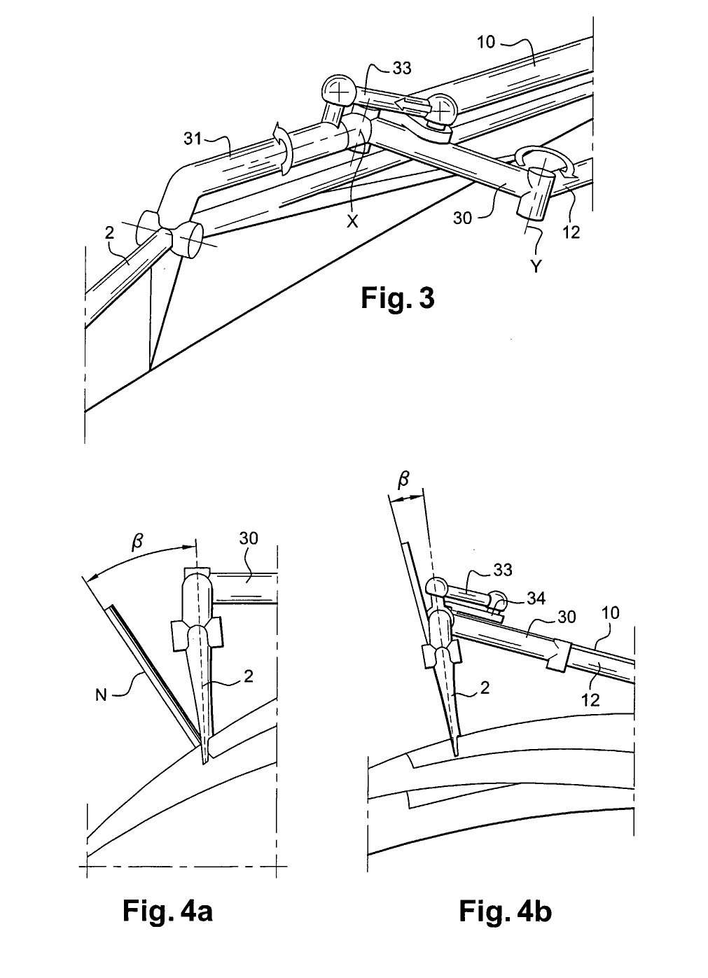

FIG. 3 shows a perspective view of the windscreen wiper in FIG. 2;

FIGS. 4a and 4b show the angles of attack of the blades in relation to the perpendicular of the windscreen in the case of a windscreen wiper of the prior art and of the windscreen wiper in FIGS. 2 and 3 respectively;

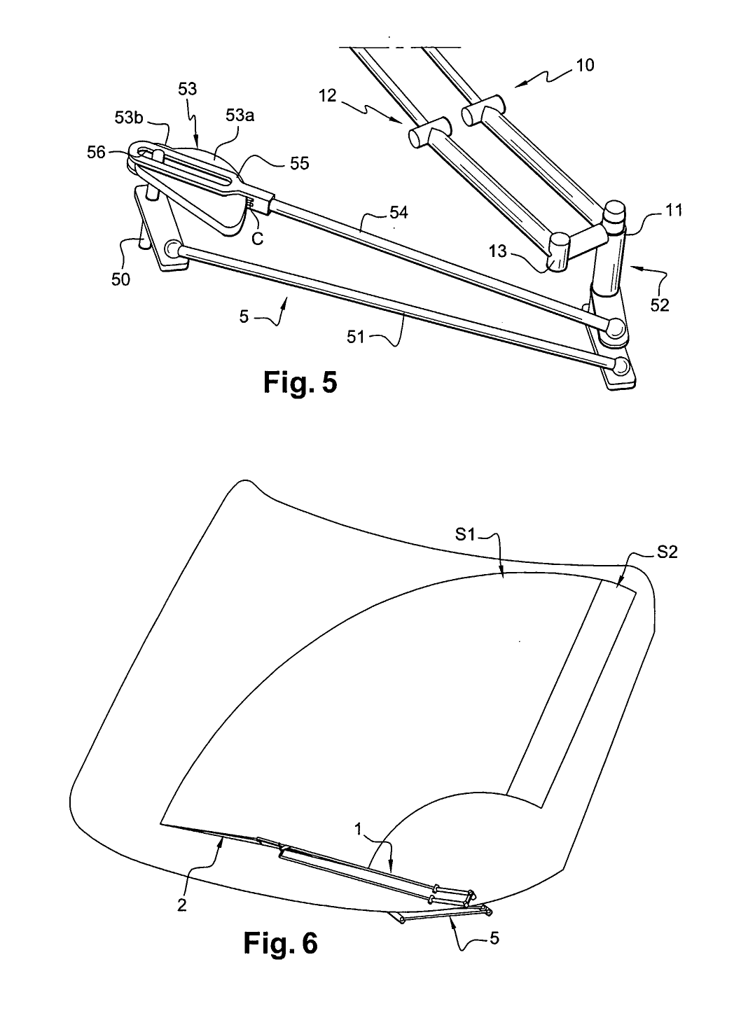

FIG. 5 shows an example of a possible embodiment of a device for powering a windscreen wiper arm according to a possible implementation of the invention;

FIG. 6 shows two sweeping sectors obtained thanks to the powering device in FIG. 5.

In order to simplify the description, elements that are common to all the figures will henceforth have the same references.

FIGS. 2 and 3 show different views of the main elements of a windscreen wiper according to a preferred embodiment of the invention. As in the windscreen wiper of the prior art described in reference to FIG. 1, the windscreen wiper in FIG. 2 comprises an arm supporting a wiper arm, the arm being made up of at least:
a main rod 10 mobile in rotation about a main swivel axis passing through a rear end of the main rod, not shown in FIGS. 2 and 3;
a secondary rod 12 mobile in rotation about a secondary swivel axis, substantially parallel to but distinct from the main swivel axis and passing through a rear end of the secondary rod, not shown in FIGS. 2 and 3;
linking means 30 connecting the front ends of the main 10 and secondary 12 rods so as to be able to swivel in the plane of the rods in relation to, on the one hand, the main rod 10 and, on the other hand, the secondary rod 12 during the rotational movements of these rods about their respective swivel axes. The axes of rotation are respectively referred to as X and Y in FIG. 3.

The concept of main rod is related in this case to the fact that it is the rod whose rotational movement is driven by the rotation of the drive shaft of an electric motor located in the device that powers the wiper arm. The other rod is called secondary because its rotational movement is driven by that of the main rod.

Also in a standard manner, the arm further comprises attachment means 31 to which the blade 2 is fixed, these attachment means 31 being solidly attached in rotation to the linking means 30 in the plane of the rods so as to have an orientation in relation to the rods which varies according to the relative angular position of these rods during their rotational movement about their respective swivel axes. Consequently, according to a standard mode of operation of a pantograph, the rotational movement of the main rod 10 about its swivel axis also drives, thanks to the linking means 30, the rotational movement of the secondary rod 12 about its swivel axis, and the parallelogram comprising the two rods 10, 12 as well as the linking means 30 can be deformed thanks to the possible swivelling about the X and Y axes. The variation of the relative angular position of the two rods resulting from this deformation causes a proportional variation of the orientation of the attachment means.

According to an essential aspect of the invention, the arm also comprises drive means 33, 34 that make it possible to transmit to the attachment means 31 a rotational movement about an axis of rotation A which is substantially perpendicular to the main and secondary swivel axes and therefore to the axes of rotation X and Y so as to change the angle of attack of the blade 2 in relation to the perpendicular of the windscreen according to the relative angular position of these rods during their rotational movement about their respective swivel axes.

Thus, thanks to the invention, it is possible simultaneously to obtain, during a sweeping operation, a correction of the angle of attack of the blade 2 on the one hand, and of the orientation of the blade 2 in relation to the windscreen generatrices on the other hand, the two corrections depending on the movement of the pantograph, which is to say, on the relative angular position of the two rods 10 and 12.

In the example of an embodiment of the invention which is particularly advantageous due to its simplicity and the reduced number of components required, shown in FIGS. 2 and 3, the arm comprises a substantially L-shaped end connecting rod, a first side of which forms the linking means 30, and a second side 32 of which, solidly attached in rotation to the first side, is connected to the attachment means 31 so as to allow the rotation of the attachment means 31 about said axis of rotation A.

The drive means comprise a connecting rod 33 connected by one end to the attachment means 31 and by the other end to a protrusion 34 of either the main or secondary rod in order for the variation of the relative angular position of the main 10 and secondary 12 rods to drive a translational movement of this connecting rod 33, which then drives said rotational movement of the attachment means 31. The various are shown schematically by the full-line arrows. In other words, the connecting rod 33 drives the rotation of the attachment means 31, and the connecting rod 30, 32 is moved in the example by the secondary rod 12 of the arm, this movement powering a reaction in the connecting rod 33 which powers the variation of the angle of attack.

In the example of an embodiment shown, the protrusion 34 comprises a fin attached to the main rod 10, which extends in a plane substantially parallel to the plane of the rods. As a variation, this fin can be attached to the secondary rod 12.

FIGS. 4a and 4b show the results obtained in terms of the angle of attack in a side area of a panoramic windscreen with a windscreen wiper of the prior art and with the windscreen wiper as described in reference to FIGS. 2 and 3, respectively. FIG. 4b clearly shows the effects of correcting the angle of attack β, which makes it possible to obtain a better angle of attack between the blade 2 and the perpendicular N of the surface of the windscreen in the case of a windscreen wiper according to the invention than in the case of the windscreen wiper of the prior art, which has too high an angle of attack β.

The pantograph windscreen wiper according to the invention as described above can comprise a standard powering device comprising an alternating rotation motor, in which the rotation of the drive shaft causes, by means of a transmission rod, the rotation of one of the rods of the arm, for example the main rod 10, about its main swivel axis, and does so on the entire surface of the windscreen to be wiped.

However, it can seem desirable only to obtain this operation in pantograph mode on certain windscreen sweeping portions, and more specifically at the end side portion, the rest of the sweeping being in a circular fashion. The following describes, in reference to FIGS. 5 and 6, an advantageous embodiment of the powering device which, in the given non-limiting example, divides the sweeping operation into two sectors: a first sector S1 (FIG. 6), ranging from the resting position to an intermediate position of the windscreen wiper, in which the rods of the blade have a circular movement, which is to say with no correction of their orientation, and a second sector S2 in which the arm operates in pantograph mode according to the invention, which is to say with simultaneous correction of the blade orientation and angle of attack according to the variation of the relative angular position of the arm rods during the deformation of the parallelogram.

In order to do this, as shown in FIG. 5, the device that powers the arm 5 comprises an electric motor with a main drive shaft 50 having an alternating direction of rotation enabling alternating sweeping of said windscreen between a resting position and an extreme position of the windscreen wiper.

In the example shown, the rotation of the drive shaft 50, by means of a rod powering the movement of the arm 51, powers the rotation of the main rod 10 about its main swivel axis passing through its rear end 11.

The powering device 5 also comprises means for controlling the arm operating mode allowing the selection, on at least one sector of the windscreen (sector S1 in the example shown), of a so-called circular operating mode, in which the main rod 10 and the secondary rod 12 move in rotation about their respective swivel axes without varying their angular position in relation to each other.

In this way, operation in pantograph mode enables a correction of the orientation, and the angle of attack is inhibited in such a way that neither the orientation nor the angle of attack of the blade 2 are subjected to modification caused by the movement of the rods 10, 12 on this sector. More specifically, the means that control the operating mode include a connecting rod 52 connecting the rear ends 11, 13 of the main 10 and secondary 12 rods respectively, a rotatingly mobile cam 53 and a pull rod 54 connecting the cam to the connecting rod 52 so as to control the connecting rod 52 according to the cam profile.

In this example, the cam comprises two different profile areas:
a first area 53a corresponding to the so-called circular operating mode, with a predefined non-circular profile, by means of which the pull rod 54 controls the rotation of the connecting rod 52 so as to prevent any variation of the relative angular position of the main rod 10 and the secondary rod 12, since the rotational movement of the connecting rod 52 compensates for any relative movement of the rods;
and a second area 53b, with a circular profile, by means of which the connecting rod 52 remains fixed; the pantograph operating mode is therefore allowed, since variations in the relative angular position of the main rod 10 and the secondary rod 12 are allowed.

In the non-limiting example shown, the drive shaft 50 is directly capable of driving the cam 53 and consequently of driving, or not, according to the cam profile 53, the movement of the pull rod 54, and thus the rotation of the connecting rod 52. An end part 55 connected to the pull rod 54 comprises an oblong opening 56 in a plane perpendicular to the drive shaft 50, which guides the point of contact C along the cam profiles.

It is evidently possible to imagine other possibilities, such as for example the use of two separate powering motors, one of them being used to power the cam. The advantage of such a solution lies, in particular, in the fact that it is possible, at clearly predefined moments corresponding to moments during which the point of contact C is on the circular profile 53b of the cam, to change the relative speeds of rotation of the two motors. The effects of correcting the orientation and angle of attack of the blade, which are normally impeded, can then be obtained locally.

FIG. 6 shows the two sweeping areas S1 and S2 obtained with a windscreen wiper according to the invention equipped with a powering device as described in FIG. 5. Evidently, there can be other areas of the windscreen in which it is desirable to correct the position and angle of attack of the blade, so as to improve the wiping quality. In this case, all it takes it to provide as many cam profiles as necessary.

The embodiments of the invention described have the advantage of being simple systems with a reduced number of components. Furthermore, it is very easy to adapt the windscreen wiper according to the invention, whether equipped with a cam powering device or not, to different vehicles having various windscreen shapes, by changing the size of the components and/or the shape of the cam.

However, these embodiments of the invention described are entirely non-limiting and certain variations can easily be implemented without departing from the framework of the invention. In particular, as regards the bulk assigned for installing the windscreen wiper, it may be necessary to have more than two rods on the arm, and different types of gears might be required for the cooperation of the various components.

Furthermore, in the context of a reduced bulk constraint and/or a style constraint, the control means for correcting the angle of attack of the blade according to the invention can be positioned at the bottom part of the pantograph instead of on the top part as in the case of the embodiment described in reference to FIGS. 2 and 3. More specifically, it is possible for the control means to allow transmission to the blade attachment means of the rotational movement about the axis of rotation substantially perpendicular to the swivel axes comprising a connecting rod connected, near the rear ends of the main and secondary rods, on the one hand to the secondary rod and, on the other hand, to a portion of the secondary rod that can be moved in rotation about said axis of rotation. This connecting rod then behaves substantially like the connecting rod 33. Evidently, the connections at the front ends of the main and secondary rods must be adapted to obtain the desired change to the angle of attack.

1. A pantograph-type windscreen wiper, in particular for an automotive vehicle comprising a panoramic windscreen, of the type including an arm supporting a blade and comprising:
a main rod mobile in rotation about a main swivel axis passing through a rear end of the main rod;
a secondary rod mobile in rotation about a secondary swivel axis, substantially parallel to but distinct from the main swivel axis and passing through a rear end of the secondary rod;
linking means connecting the front ends of the main and secondary rods so as to be able to swivel in the plane of the rods in relation to, on the one hand, the main rod and, on the other hand, the secondary rod during the rotational movements of these rods about their respective swivel axes;
attachment means to which the blade is fixed, the attachment means being solidly attached in rotation to the linking means in the plane of the rods so as to have an orientation in relation to the rods which varies according to the relative angular position of these rods during their rotational movement about their respective swivel axes;
characterised in that the ann also comprises drive means which transmit to said attachment means a rotational movement about an axis of rotation (A) substantially perpendicular to the swivel axes so as to vary the angle of attack of the blade in relation to the perpendicular (N) of the windscreen according to the relative angular position of these rods during their rotational movement about their respective swivel axes.

2. The pantograph-type windscreen wiper according to claim 1, characterised in that the arm comprises a substantially L-shaped end connecting rod, a first side of which forms the linking means, and a second side of which solidly attached in rotation to the first side, is connected to the attachment means so as to allow the rotation of the attachment means about said axis of rotation (A), and in that the drive means comprise a connecting rod connected by one end to the attachment means and by the other end to a protrusion of either the main or secondary rod in order for the variation of the relative angular position of the main and secondary rods to drive a translational movement of the connecting rod, which then controls said rotational movement of the attachment means.

3. The pantograph-type windscreen wiper according to claim 2, characterised in that said protrusion comprises a fin attached to either the main or secondary rod, extending in a plane substantially parallel to the plane of the rods.

4. The pantograph-type windscreen wiper according to claim 1, characterised in that it also comprises an arm powering device comprising at least one electric motor with a main drive shaft having an alternating direction of rotation enabling alternating sweeping of said windscreen between a resting position and an extreme position of the windscreen wiper, and means for controlling the arm operating mode allowing the selection, on at least one sector of the windscreen, of a so-called circular operating mode, in which the main rod and the secondary rod move in rotation about their respective swivel axes without varying their angular position in relation to each other.

5. The pantograph-type windscreen wiper according to claim 4, characterised in that the powering device is sized to allow the so-called circular operating mode to be selected on at least one sector located between the resting position and a side end area.

6. The pantograph-type windscreen according to claim 4, characterised in that the means that control the operating mode comprise a connecting rod connecting the rear ends of the main and secondary rods respectively, a rotatingly mobile cam and a pull rod connecting the cam to the connecting rod so as to control the connecting rod according to the cam profile, said cam comprising at least two different profile areas, a first area corresponding to the so-called circular operating mode, by means of which the pull rod controls the rotation of the connecting rod so as to prevent any variation of the relative angular position of the main rod and the secondary rod, and a second area by means of which the connecting rod remains fixed so as to allow variations in the relative angular position of the main rod and the secondary rod.

7. The pantograph-type windscreen wiper according to claim 6, characterised in that the cam is driven in rotation about the main drive shaft by said electric motor.

8. The pantograph-type windscreen wiper according to claim 6, characterised in that the cam is driven in rotation by an additional electric motor.

9. The pantograph-type windscreen wiper according to claim 8, characterised in that, in circular operating mode, the relative speeds of rotation of the driving motor and the additional motor vary in order to obtain local correction of the angle of attack and orientation of the blade.

10. The pantograph-type windscreen wiper according to claim 6, characterised in that the powering device comprises an end part connected to the pull rod, said end part comprising an oblong opening in a plane perpendicular to the axis of rotation of the cam for guiding the point of contact (C) of the end part along the cam profiles.

11. The pantograph-type windscreen wiper according to claim 1, characterised in that the control means comprise a connecting rod connected, near the rear ends of the main and secondary rods, on the one hand to the secondary rod and, on the other hand, to a portion of the secondary rod that can be moved in rotation about said axis of rotation.

12. The pantograph-type windscreen wiper according to claim 2, characterised in that it also comprises an arm powering device comprising at least one electric motor with a main drive shaft having an alternating direction of rotation enabling alternating sweeping of said windscreen between a resting position and an extreme position of the windscreen wiper, and means for controlling the ann operating mode allowing the selection, on at least one sector of the windscreen, of a so-called circular operating mode, in which the main rod and the secondary rod move in rotation about their respective swivel axes without varying their angular position in relation to each other.

13. The pantograph-type windscreen wiper according to claim 3, characterised in that it also comprises an ann powering device comprising at least one electric motor with a main drive shaft having an alternating direction of rotation enabling alternating sweeping of said windscreen between a resting position and an extreme position of the windscreen wiper, and means for controlling the arm operating mode allowing the selection, on at least one sector of the windscreen, of a so-called circular operating mode, in which the main rod and the secondary rod move in rotation about their respective swivel axes without varying their angular position in relation to each other.

14. The pantograph-type windscreen according to claim 5, characterised in that the means that control the operating mode comprise a connecting rod connecting the rear ends of the main and secondary rods respectively, a rotatingly mobile cam and a pull rod connecting the cam to the connecting rod so as to control the connecting rod according to the cam profile, said cam comprising at least two different profile areas, a first area corresponding to the so-called circular operating mode, by means of which the pull rod controls the rotation of the connecting rod so as to prevent any variation of the relative angular position of the main rod and the secondary rod, and a second area by means of which the connecting rod remains fixed so as to allow variations in the relative angular position of the main rod and the secondary rod.

15. The pantograph-type windscreen wiper according to claim 7, characterised in that the powering device comprises an end part connected to the pull rod, said end part comprising an oblong opening in a plane perpendicular to the axis of rotation of the cam for guiding the point of contact (C) of the end part along the cam profiles.

16. The pantograph-type windscreen wiper according to claim 8 characterised in that the powering device comprises an end part connected to the pull rod, said end part comprising an oblong opening in a plane perpendicular to the axis of rotation of the cam for guiding the point of contact (C) of the end part along the cam profiles.

17. The pantograph-type windscreen wiper according to claim 9 characterised in that the powering device comprises an end part connected to the pull rod, said end part comprising an oblong opening in a plane perpendicular to the axis of rotation of the cam for guiding the point of contact (C) of the end part along the cam profiles.
